(19) United States
(12) Patent Application Publication
(10) Pub. No.: US 2006/0145064 A1
(43) Pub. Date: Jul. 6, 2006

(54) Projection system

(76) Inventors: Peter Lurkens, Aachen (DE); Carsten Deppe, Aachen (DE); Gero Heusler, Aachen (DE); Holger Monch, Vaals (DE)

Correspondence Address: PHILIPS INTELLECTUAL PROPERTY & STANDARDS, P.O. BOX 3001, BRIARCLIFF MANOR, NY, 10510, US

(21) Appl. No.: 10/560,633

(22) PCT Filed: Jun. 3, 2004
(86) PCT No.: PCT/IB04/50832

§ 371 Date: Dec. 13, 2005

(30) Foreign Application Priority Data
Jun. 16, 2003 (EP) 03101761.9

(51) Int. Cl. G01J 1/00

(52) U.S. Cl. 250/228

(57) ABSTRACT

A projection system for image display with at least one lamp (1), with at least one sensor (5) for detecting changes in the luminous flux delivered by said at least one lamp (1) and for compensating these changes through a suitable control of the image display and/or the lamp is described. The projection system is remarkable in that a light integrator (3) is provided, into which at least a portion of the light provided by the lamp (1) is coupled in, while the sensor (5) is optically coupled to the light integrator (3) such that it detects the luminous intensity present in the light integrator (3). Since this luminous intensity is very homogeneous because of the multiple reflections and is not influenced by brightness fluctuations caused by an optical component such as, for example, a color modulator (4), a very accurate compensation of changes in the luminous flux generated by the lamp (1) is made possible by the sensor signal.

The invention relates to a projection system for image display with at least one lamp and at least one sensor for detecting changes in the luminous flux delivered by said at least one lamp and for compensating these changes through a suitable control of the image display and/or the lamp.

One or several high-pressure gas discharge lamps (HID [high intensity discharge] lamps or UHP [ultra high performance] lamps) are generally used as light sources in projection systems. An advantage of these lamps is inter alia that they have a comparatively short discharge arc and thus a very small dimension of the luminous surface, so that a very high proportion of the generated light can be directed into an imaging system, for example by means of a reflector in whose focus the discharge arc is located. The advantages of the almost point-shaped light emission may be utilized correspondingly also for other applications such as, for example, in spotlights or for illumination purposes, because the radiation characteristic of a reflector can be approximated substantially more closely to a desired ideal gradient thereby.

The small luminous region, however, also involves the risk that the system is defocused in the case of only a small localized shift between reflector and lamp or discharge arc, whereby the radiation characteristic and thus the luminous flux in given locations is considerably changed. These shifts may be caused in particular by a leap of the discharge arc, for example owing to an erosion of the electrodes and the concomitant change in their shape or their state.

This may lead to interfering fluctuations in the brightness of the generated image which are perceived as unpleasant, in particular in the case of an imaging system, because the proportion of the light coupled into the imaging system changes correspondingly.

The lamps mentioned above may be operated in principle both with direct current and with alternating current. Both modes of operation have their advantages and disadvantages. A quick erosion of the electrodes is prevented and the luminous efficacy of the lamp can be increased by an alternating current, but the arc discharge is often unstable here owing to the polarity change, so that periodic brightness fluctuations or other image disturbances may arise. With direct current, however, it cannot be excluded either that instabilities of the arc discharge arise, in particular with an increasing duration of operation, for example owing to an electrode spacing that has become irregular in the intervening time, which may manifest itself in particular in the form of arc leaps.

To safeguard an optimum, interference-free image quality throughout the life of a discharge lamp, therefore, sensors should be provided in both modes of operation for monitoring the luminous flux provided and for providing a suitable compensation of short-term fluctuations (and possibly also a long-term luminous decrement).

Fluctuations in the emitted luminous flux may become particularly unpleasant, in particular in color projection systems operating with time-sequential color rendering methods, if one of the primary colors is shown with a brightness different from that of the other primary colors, or if the brightness of this one color in certain image regions of the display differs from the brightness in other regions of the display.

Two time-sequential color display methods are distinguished and utilized in particular nowadays:

In a first method, the color image is generated on the display through a sequential representation of full pictures in the three basic colors (“field sequential color”) plus possibly a fourth, white image. This method is used at the moment, for example, in most DLP (digital light processing) projectors.

In a second method, the color image is generated in that the primary colors run over the display one after the other in the form of color beams or color strips (“scrolling color”). This method is used, for example, by the present applicant's LCOS (liquid crystal on silicon) displays (cf. Shimizu: “Scrolling Color LCOS for HDTV Rear Projection”, in SID 01 Digest of Technical Papers vol. XXXII, pp. 1072 to 1075, 2001), and SCR-DMD (sequential color recapture-digital micro mirror) projection displays (cf. Dewald, Penn, Davis: “Sequential Color Recapture and Dynamic Filtering: A Method of Scrolling Color” in SID 01 Digest of Technical Papers, vol. XXXII, pp. 1076 to 1079, 2001).

These systems comprise a color separation or color filtering and a modulator for the color components between the lamp and the display for the generation of light with the three primary colors. The color separation and the modulator may be integrated with one another to a greater or lesser extent. Thus the color filtering and modulation are carried out by a rotating filter wheel in the SCR systems, whereas the color filtering takes place with mirrors and the modulation with prisms in the LCOS system of the present applicant. It is common to all systems, however, that the modulation causes considerable brightness fluctuations in the optical system. Furthermore, the sensitivity of conventional sensors to the various color components is very different. The fluctuations thus caused in the output signal of a sensor arranged in the radiation path or at the display render this sensor useless for controlling the lamp or the image brightness.

In addition, the sensor is to sense a signal which is exactly proportional to the luminous flux actually hitting the display if it is to render possible a correct control. This is usually not guaranteed, not for positions of the sensor outside the radiation path of the light, and not for positions in front of the optical integration either.

DE 101 36 474.1, for example, discloses an electronic control circuit for operating a HID or UHP lamp, comprising a lamp driver for providing a controlled lamp current for the lamp and a brightness sensor for generating a sensor signal representing the luminous flux generated by the lamp. A high-pass or bandpass filter is furthermore provided, by means of which the sensor signal is filtered and is subsequently supplied to the lamp driver for controlling the lamp current.

The object of the high-pass or bandpass filter is to separate long-term changes in the luminous flux provided by the lamp, in particular a luminous decrement as lamp life progresses, from the short-term fluctuations caused by arc leaps, such that only the latter fluctuations are used in the active control of the lamp power by the lamp driver.

Such an active control (LOC-light output control), however, cannot operate reliably if the sensor signal is superimposed with interfering components which are caused, for example, by the brightness fluctuations originating from a color modulator, as was explained above.

It is accordingly an object of the invention to provide a projection system of the kind mentioned in the opening paragraph in which impairments of the image quality caused by unwanted changes in the luminous flux provided by the lamp (in particular owing to arc leaps) can be avoided at least substantially also in the presence of regular brightness fluctuations caused by an optical component of the projection system.

The invention particularly aims to provide a projection system which comprises at least one high-pressure gas discharge lamp and in which impairments of the image quality owing to fluctuations in the generated luminous flux, in particular caused by an unstable arc discharge, can be avoided at least substantially also with the use of a time-sequential color representation.

Finally, the invention also aims to provide a projection system with time-sequential color representation in which color artifacts caused by an unwanted change in the luminous flux provided by the lamp are avoided at least substantially, in particular if one or several high-pressure gas discharge lamps operated on alternating current are used as the lamp or lamps.

The object is achieved according to claim 1 by means of a projection system for image display with at least one lamp and at least one sensor for detecting changes in the luminous flux delivered by said at least one lamp and for compensating these changes through a suitable control of the image display and/or the lamp, and with a light integrator into which at least a portion of the light provided by the lamp is coupled in, wherein the sensor is optically coupled to the light integrator such that it detects the luminous intensity present in the light integrator.

Since the light entering the light integrator including the light components possibly reflected back by a color modulator into the exit surface of the light integrator is homogenized by multiple reflections, the generated sensor signal is at least not substantially superimposed with interfering components of the color modulator or other optical components in the projection system, so that it can be used for controlling the image display and/or the lamp. A suitable dimensioning of the length of the light integrator renders it possible to reduce the interfering components to an acceptable level, or indeed substantially to any extent desired.

A particular advantage of this solution is that such a light integrator is usually already present in the color projection systems mentioned in the opening paragraph, so that no measures are necessary in the direct light path and the projection system according to the invention can be realized with a comparatively small additional expenditure.

Furthermore, the sensor is not positioned in the light path of the projection system and thus causes no perceivable interferences or shadow effects, i.e. light losses.

Finally, the sensor signal generated in accordance with the invention may also be used for the active control of the lamp (LOC) mentioned above.

The dependent claims relate to advantageous further embodiments of the invention.

The embodiments of claims 2, 3, and 4 relate to preferred methods of optically coupling the at least one sensor to the light integrator.

A suitable arrangement or positioning of the at least one sensor in certain regions or locations of the light integrator as claimed in claim 5 and/or 6 renders it possible to optimize the detection of the luminous intensity in particular in those cases in which colored light components are reflected back into the light integrator through an exit surface thereof, for example by a color modulator.

Claim 7 relates to a preferred control of the image representation for the purpose of compensating changes in the luminous flux provided by the lamp.

A filtering of the sensor signal according to claim 8 renders it possible to make a purpose-oriented choice of the changes in the luminous flux that are to be compensated in relation to their frequency.

Claim 9, finally, relates to a preferred application of the principle of the invention.

Further details, features, and advantages of the invention will become apparent from the ensuing description of embodiments which are shown by way of example in the drawing, in which:

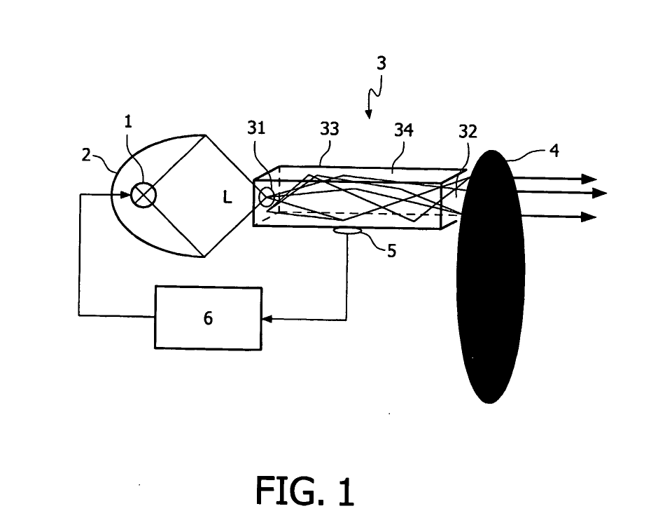

FIG. 1 diagrammatically shows essential components of an SCR projection system with a first sensor positioning;

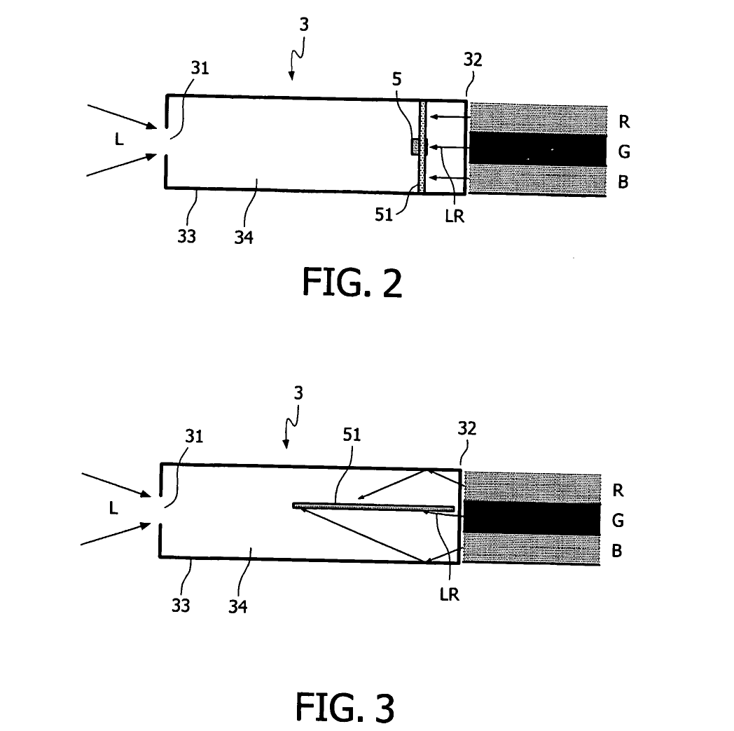

FIG. 2 shows a detail from FIG. 1 with a second sensor positioning; and

FIG. 3 shows a detail from FIG. 1 with a third sensor positioning.

The invention will now be explained with reference to a projection system operating by the second method mentioned above (scrolling color system) with an SCR-DMD display. The construction and manner of operation of such a projection system are explained in detail in the cited article by Dewald, Penn, Davis: “Sequential Color Recapture and Dynamic Filtering: A Method of Scrolling Color” in SID 01 Digest of Technical Papers, vol. XXXII, pp. 1076 to 1079, 2001. This article is to be considered included in the present description by reference.

FIG. 1 shows the construction principle of the lighting portion of such a projection system. This Figure shows a light source with at least one lamp 1 and at least one reflector 2 as well as a light integrator (rod integrator) 3, into whose entry window 31 the light generated by the lamp 1 is focused in the form of a light cone L formed by the reflector 2. The light integrator 3 has an exit surface 32 at an end opposed to the entry window 31, at which surface 32 a color wheel 4 is arranged.

The lamp 1 is in particular a high-pressure gas discharge lamp (HID [high intensity discharge] lamp or UHP [ultra high performance] lamp).

The light integrator 3 (provided it is long enough) generates a homogeneously distributed luminous intensity locally and temporally at its exit surface 32. The light integrator 3 for this purpose comprises a highly reflective sheath 33 which encloses a hollow space 34. The light coupled into the entry window 31 is multiply reflected against the sheath 33, as are the light components reflected back by reflection at the color wheel 4 through the exit surface 32 into the light integrator 3, and the light is homogenized, given a sufficient length of the light integrator 3, such that the desired, homogeneous distribution of luminous intensity is achieved at the exit surface 32 thereof. The entry window 31 is made as small as possible in order to minimize light losses caused thereby.

The light integrator 3 may alternatively be formed by a solid optical waveguide of an optically guiding material, in particular glass or a suitable synthetic resin.

The color wheel 4 which is known per se is arranged at the exit surface 32. This color wheel 4 (color modulator) comprises red, green, blue, and transparent coatings, all diachronically reflecting, which are arranged in the form of an RGB pattern of Archimedean spirals. The pattern is dimensioned such that at any time one or several colored spirals cover the cross-section of the exit surface 32 of the light integrator 10. The pattern has the characteristic that the boundaries between the colors red, green, and blue move with constant velocity in radial direction when the color wheel 4 is rotated. As a result, the RGB pattern of the color wheel 4 moves with substantially constant velocity over the exit surface 32 of the light integrator 3. The distance between the exit surface 32 and the color wheel 4 should be as small as possible so as to avoid light losses.

The RGB pattern generated by the color wheel 4 is directed at a DMD display by means of a relay lens (projection optics), both components not being shown, which display is controlled in a known manner by a control device. Rotation of the color wheel 4 creates the color strips sequentially traversing the DMD display, as described above. The image generated on the DMD display is finally projected onto a wall or a screen or some similar item (not shown) by means of a lens.

At least one sensor 5 is provided, which is connected to a lamp driver (power supply unit) 6 of the lamp for the purpose of avoiding brightness fluctuations in the image caused by changes in the luminous flux of the lamp, for example owing to leaps of the discharge arc in the lamp 1, caused again by an unwanted change in the lamp current or other effects, which sensor 5 controls the lamp on the basis of the detected luminous intensity such that the lamp current is increased when the luminous flux decreases and is decreased when the luminous flux increases.

The sensor 5 is optically coupled to the light integrator 3 such that the sensor detects the luminous intensity inside the light integrator 3. The light here is very homogeneous, as was explained above, and is not subject to the brightness fluctuations caused by the color wheel 4. Changes in the luminous flux generated by the lamp 1 can thus be detected free from interferences and can be effectively compensated by means of a suitable control of the lamp driver 6.

The sensor 5 is preferably arranged such that it detects exclusively the light present in the light integrator 3. This may be achieved in that the sensor 5 is directly mounted against the sheath 33, as in FIG. 1, which sheath is provided with an at least partly transmitting window for the sensor 5.

Furthermore, the sensor 5 may also be optically connected to the hollow space 34 of the light integrator 3 via an optical waveguide, or it may even itself be arranged inside the hollow space 34 of the light integrator 3, provided it is sufficiently temperature-resistant.

FIGS. 2 and 3 show portions from FIG. 1 on an enlarged scale. The light integrator 3 with its sheath 33 and the hollow space 34 is shown in detail here. A light cone L of a light source is directed again into the entry window 31, while at the opposite end of the light integrator 3 a color modulator is present which generates the diagrammatically indicated primary colors red (R), green (G), and blue (B). The color modulator reflects light components LR of these primary colors back into the light integrator 3 through the exit surface 32 thereof.

It is to be taken into account in the choice of an optimized sensor position that the color strips move one after the other over the exit surface 32 of the light integrator 3 and that the light components LR reflected back may possibly not be optimally mixed with the light L coupled into the entry window 31 in the case of a too short light integrator 3 because of the small number of reflections. In this case the sensor signal will fluctuate in the frequency of the color strips.

To avoid this, a sensor position is to be chosen which is as evenly exposed as possible to all reflections. This means that rays of all color components should hit the sensor in as equal a measure as possible, also if these rays traverse the exit surface 32 of the light integrator 3 in conformity with the movement of the color strips.

FIG. 2 shows by way of example a first positioning in which for this purpose a sensor surface in the form of a light-receiving strip 51 (for example made of glass or synthetic resin) is provided on the sheath 33 of the light integrator 3, such that the strip 51 extends substantially parallel to the exit surface 32 of the light integrator 3, and the sheath 33 is at least partly transmittive to the light present in the light integrator 3 below the strip 51. The strip 51 may extend over the full circumference of the light integrator 3 or only over a portion of its circumference, or its height and/or width. The width of the strip 51 preferably corresponds to approximately one color cycle here.

The strip 51 in this position receives the light components LR reflected back substantially directly, i.e. without previous reflection against the sheath 33 of the light integrator 3.

The sensor 5 proper may be arranged in a position along this strip 51 and may be, for example, a known semiconductor sensor, or the strip 51 itself is constructed, for example, as a (silicon) sensor.

FIG. 3 shows a second positioning in which the light-receiving strip 51 provided on the sheath 33 extends substantially perpendicularly to the exit surface 32, i.e. in axial direction of the light integrator 3 along at least a portion of the length thereof. Below the strip 51, the sheath 33 is again partly transmittive to the light present in the light integrator 3. The width of the strip 51 is determined substantially in dependence on the color filters and the angles of the rays LR reflected against the sheath 33.

Given this positioning, the strip 51 accepts the light components LR reflected back substantially after a reflection against the sheath 33 of the light integrator 3.

The sensor 5 proper may be arranged in a location along the strip 51 also in this case and may be, for example, a known semiconductor sensor, or the strip 51 itself is constructed, for example, as a (silicon) sensor.

The use of the light-receiving strip 51 improves the coupling-out of light owing to a better mixing of all light components in both cases.

It is true in general that the sensor arrangement and positioning are the more uncritical as the light integrator 3 is longer.

An advantage of the sensor arrangements is also that the local and temporal homogeneity of the luminous intensity at the exit surface 32 of the light integrator 3 can be improved thereby also during the time intervals in which the lamp provides a constant luminous flux. An overall improvement in the image quality is obtained in this manner.

The principle of the invention may be advantageously combined also with the electronic circuit for operating a HID or UHP lamp known from the cited DE 101 36 474.1 when the brightness sensor described therein is replaced with a sensor arranged in the manner of the present invention.

In the embodiments described above, the control of the image display, whereby changes in the luminous flux generated by the lamp are compensated, takes place through a control of the lamp current (and thus of the image brightness) in that the sensor signal is applied to the lamp driver 6.

Alternatively or in addition thereto, however, it is also possible to change the brightness of the image by means of an optical filter that can be electrically controlled by the sensor signal and that is introduced (additionally) into the radiation path between the lamp and the display, and/or by means of a gray level mask in the form of a factor with which the brightness of the image representation on the display is influenced in dependence on the sensor signal.

These two alternative brightness controls, which are particularly suitable for the very fast displays used in the DLP systems, are described in detail in DE 102 20 510.8. This publication is to be regarded as forming part of the present disclosure by reference, so that it need not be discussed in any detail below.

The principle of the invention is obviously also applicable to those lighting systems which in themselves do not comprise a light integrator, to the extent to which the application and the construction of such a system render possible the use of a corresponding light integrator in at least a portion of the light path.

1. A projection system for image display with at least one lamp (1), with at least one sensor (5) for detecting changes in the luminous flux delivered by said at least one lamp (1) and for compensating these changes through a suitable control of the image display and/or the lamp, and with a light integrator (3) into which at least a portion of the light provided by the lamp (1) is coupled in, wherein the sensor (5) is optically coupled to the light integrator (3) such that it detects the luminous intensity present in the light integrator (3).

2. A projection system as claimed in claim 1, wherein the sensor (5) is arranged at a sheath (33) of the light integrator (3), said sheath (33) having a window which is at least partly transmittive to the light present in the light integrator (3), through which window the light is incident on the sensor (5).

3. A projection system as claimed in claim 1, wherein the at least one sensor (5) is arranged inside the light integrator (3).

4. A projection system as claimed in claim 1, wherein the at least one sensor (5) is optically coupled to the light integrator (3) by means of an optical waveguide.

5. A projection system as claimed in claim 1, wherein the at least one sensor (5) has a sensor surface (51) against or inside the light integrator (3), which surface extends substantially parallel to the exit surface (32) of the light integrator (3).

6. A projection system as claimed in claim 1, wherein the at least one sensor (5) has a sensor surface (51) against or inside the light integrator (3), which surface extends substantially perpendicularly to the exit surface (32) of the light integrator (3).

7. A projection system as claimed in claim 1, wherein the control of the image representation takes place in that the output signal of the at least one sensor (5) is applied to a lamp driver (6).

8. A projection system as claimed in claim 1, wherein the output signal of the at least one sensor (5) is filtered by means of a filter for the purpose of compensating changes in the luminous flux generated by the lamp (1) which occur with a given frequency.

9. A projection system as claimed in claim 1 for the representation of color images through the time-sequential generation of primary colors on a display, comprising a light integrator (3) to which the at least one sensor (5) is optically coupled.
